(19) United States
(12) Patent Application Publication
(10) Pub. No.: US 2026/0101854 A1
(43) Pub. Date: Apr. 16, 2026

(54) PLANT SHELTER SYSTEM, APPARATUS, AND METHOD

(71) Applicant: Austen Yelverton Blakey, Stanardsville, VA (US)

(72) Inventor: Austen Yelverton Blakey, Stanardsville, VA (US)

(21) Appl. No.: 18/917,609

(22) Filed: Oct. 16, 2024

(51) Int. Cl. A01G 13/02; A01G 13/10

(52) U.S. Cl. CPC A01G 13/28; A01G 13/10

(57) ABSTRACT

A method is disclosed. The method includes forming a structural assembly having an interior area based on removably attaching a plurality of structural members and a plurality of mechanical connectors, removably attaching a waterproof barrier to the structural assembly as a roof to the structural assembly, the waterproof barrier being at least one of translucent or transparent, removably attaching at least one open mesh barrier to the structural assembly as side walls to the structural assembly, removably attaching a plurality of bracing members to the structural assembly, and disposing plants in the interior area.

### TECHNICAL FIELD

The present disclosure generally relates to a shelter system, apparatus, and method, and more particularly to a plant shelter system, apparatus, and method.

### BACKGROUND

Plant shelters are typically used to allow for the growing of plants both inside and outside of a natural growing season and/or a natural growing climate. Plant shelters are also used to enhance the growth of plants by protecting the plants from weather and disease. For example, disease such as various fungi may negatively affect plants in many circumstances.

One such fungus is Botrytis cinerea, also known as gray mold or Bud Rot. Bud Rot may negatively affect plants such as fruit (strawberries or wine grapes), cannabis, and many other crops. Bud Rot is typically caused by excessive moisture, and can wipe out entire crops relatively quickly, often within a few days.

One way of preventing Bud Rot is through the use of resilient and robust greenhouses equipped with dehumidification systems. Although such shelters are effective in preventing Bud Rot including during inclement weather based on their robust structural integrity, they involve relatively expensive structural systems and construction materials. Accordingly, the cost of such effective systems is typically out of the reach financially of many growers.

Although cheaper systems such as tents and low-cost shelters that attempt to replicate greenhouses can be used, these low-cost systems lack resilience and durability. Such structures include temporary structures such as tents and low-cost greenhouses. These systems may be damaged or destroyed by inclement weather such as wind and heavy rain. Such low-cost systems often exhibit tears, structural instability, and/or collapse within a short time, typically within weeks or even days after they are erected, depending on weather conditions.

Accordingly, a need in the art exists for plant shelters that are both effective and of a reasonable price that is within financial reach of most growers.

The exemplary disclosed system, apparatus, and method of the present disclosure are directed to overcoming one or more of the shortcomings set forth above and/or other deficiencies in existing technology.

### SUMMARY OF THE DISCLOSURE

In one exemplary aspect, the present disclosure is directed to a method. The method includes forming a structural assembly having an interior area based on removably attaching a plurality of structural members and a plurality of mechanical connectors, removably attaching a waterproof barrier to the structural assembly as a roof to the structural assembly, the waterproof barrier being at least one of translucent or transparent, removably attaching at least one open mesh barrier to the structural assembly as side walls to the structural assembly, removably attaching a plurality of bracing members to the structural assembly, and disposing plants in the interior area.

In another aspect, the present disclosure is directed to apparatus for sheltering plants. The apparatus includes a plurality of mechanical connectors including at least one of 3-way connectors or 4-way connectors and at least one of 5-way connectors or 6-way connectors, a plurality of structural members configured to be removably attached to the plurality of mechanical connectors, a waterproof barrier configured to be removably attached to the plurality of structural members using a plurality of barrier connectors, the waterproof barrier being at least one of translucent or transparent, at least one open mesh barrier configured to be removably attached to the plurality of structural members using the plurality of barrier connectors, and a plurality of tensioning straps configured to be removably attached to at least one of the plurality of structural members or the plurality of mechanical connectors.

### BRIEF DESCRIPTION OF THE DRAWINGS

FIG. 1 is a perspective view of an exemplary embodiment of the present invention;

FIG. 2 is another perspective view of the exemplary embodiment of the present invention illustrated in FIG. 1;

FIG. 3 is a schematic view of the exemplary embodiment of the present invention illustrated in FIG. 1;

FIG. 4A is a detailed, exploded view of a portion of the exemplary embodiment of the present invention illustrated in FIG. 1;

FIG. 4B is another detailed, exploded view of a portion of the exemplary embodiment of the present invention illustrated in FIG. 1;

FIG. 4C is another detailed, exploded view of a portion of the exemplary embodiment of the present invention illustrated in FIG. 1;

FIG. 4D is a side, perspective view of an exemplary embodiment of the present invention;

FIG. 5 is another schematic view of the exemplary embodiment of the present invention illustrated in FIG. 1;

FIG. 6 is top, schematic view of the exemplary embodiment of the present invention illustrated in FIG. 1;

FIG. 7 is a detailed, schematic view of a portion of the exemplary embodiment of the present invention illustrated in FIG. 1;

FIG. 7A is a detailed view of a portion of the exemplary embodiment of the present invention illustrated in FIG. 7;

FIG. 8 is another schematic view of the exemplary embodiment of the present invention illustrated in FIG. 1; and

FIG. 9 illustrates an exemplary process of at least some exemplary embodiments of the present disclosure.

### DETAILED DESCRIPTION AND INDUSTRIAL APPLICABILITY

The exemplary disclosed system, apparatus, and method may provide a plant shelter for growing plants. For example, the exemplary disclosed system, apparatus, and method may provide an outdoor plant shelter for growing plants. The exemplary disclosed system, apparatus, and method may be used to protect any desired plants (e.g., such as cannabis, fruit, and/or any other suitable crops) from disease and weather conditions both inside and outside of a natural growing season and/or a natural growing climate. For example, the exemplary disclosed system, apparatus, and method may be used to protect plants against Bud Rot.

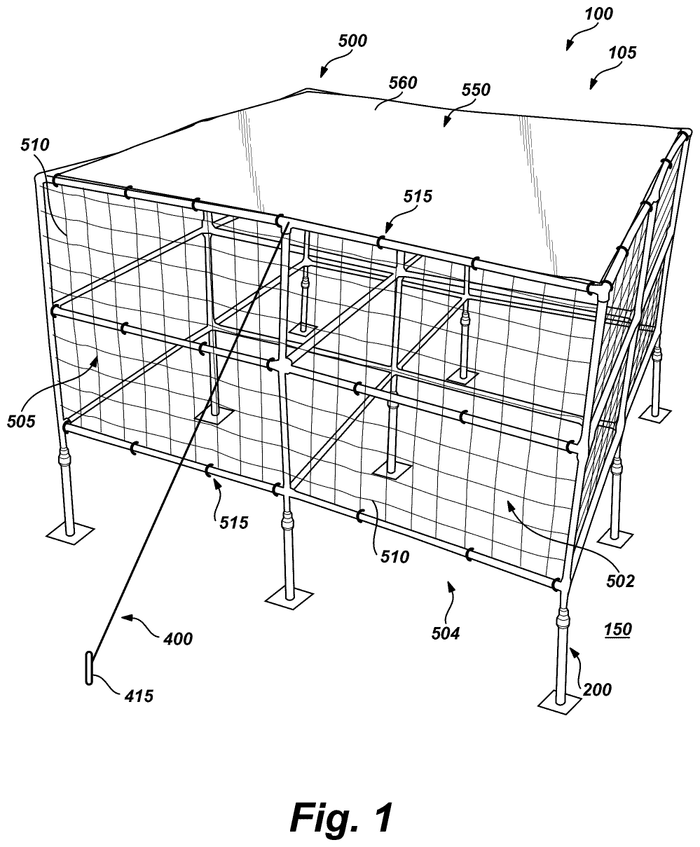

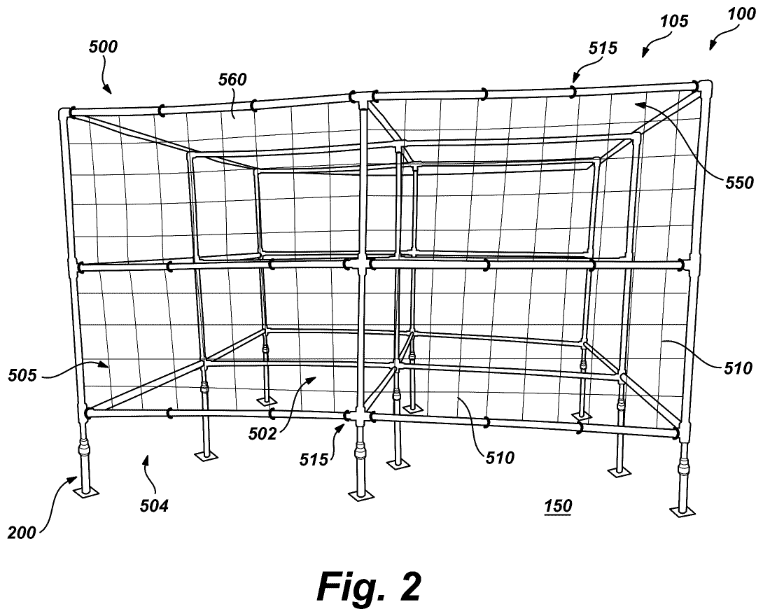

As illustrated in FIGS. 1 and 2, the exemplary disclosed system, apparatus, and method may include providing a shelter system 100 including an apparatus 105. Apparatus 105 may include a structural assembly 200, a bracing assembly 400, and a barrier assembly 500. Barrier assembly 500 may be disposed on structural assembly 200, which may be braced by bracing assembly 400. Structural assembly 200 may support apparatus 105 on a ground surface 150. Ground surface 150 may be any suitable surface for supporting apparatus 105 such as, for example, earth (e.g., grass, soil, and/or any other suitable surface in which a plant may grow). Ground surface 150 may be earth covered with gravel. In at least some exemplary embodiments, ground surface 150 may be sand, concrete, and/or any other desired support surfaces on which plants (e.g., in pots or other suitable containers including soil) may be disposed.

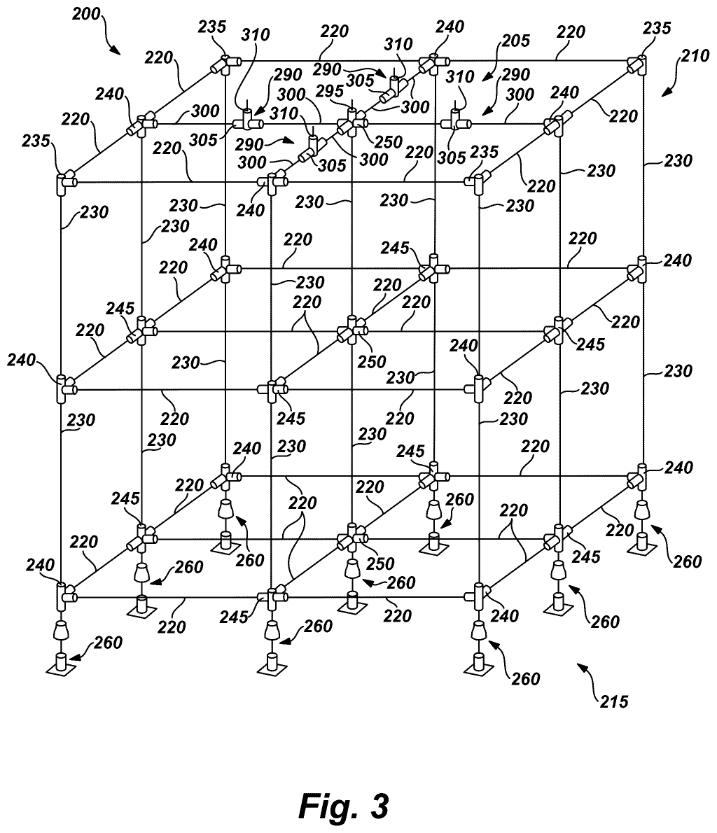

As illustrated in FIG. 3, structural assembly 200 may include an upper assembly 205, a main assembly 210, and a lower assembly 215. Lower assembly 215 may structurally support main assembly 210 on ground surface 150. Main assembly 210 may structurally support upper assembly 205.

Main assembly 210 may include a plurality of structural members and a plurality of mechanical connectors. For example, main assembly 210 may include a plurality of horizontal members 220, a plurality of vertical members 230, and a plurality of mechanical connectors that may connect horizontal members 220 and vertical members 230 for example as described below.

Horizontal member 220 may be an elongated member. Horizontal member 220 may be any suitable structural shape such as, for example, a pipe, a tube, a flanged member, a channel, an I-beam, a rod, and/or any other suitable structural shape. In at least some exemplary embodiments, horizontal member 220 may be an elongated, hollow member. For example, horizontal member 220 may be a pipe or a tube (e.g., a structural pipe or a tube member). Horizontal member 220 may have a cross-section that may be annular (e.g., circular or elliptical), rectangular (e.g., square), polygonal, and/or any other desired configuration (e.g., cross-sectional configuration).

Horizontal member 220 may be formed from structural plastic, metal, composite material, wood, fabric, ceramic, and/or any other suitable structural material. In at least some exemplary embodiments, horizontal member 220 may be formed from one or more thermoplastic polymeric materials. Horizontal member 220 may be formed from polyvinyl chloride (PVC) material, acrylonitrile butadiene styrene (ABS) material, polycarbonate material, PPS material, Polypropylene, HDPE, and/or any other suitable structural material. In at least some exemplary embodiments, horizontal member 220 may be formed from PVC or ABS material such as PVC or ABS hollow members (e.g., PVC or ABS pipe).

Vertical member 230 may be similar to the exemplary disclosed members described above and formed from similar material as described above regarding horizontal member 220. Horizontal members 220 and vertical members 230 may have any suitable dimensions for forming structural assembly 200 of a desired size, shape, and/or configuration. For example, horizontal members 220 and vertical members 230 may have a length of between about 1 foot (e.g., or less) and about 10 feet (e.g., or more), between about 2 feet and about 8 feet, between about 2.5 feet and about 5 feet, or any other suitable length. In at least some exemplary embodiments, horizontal members 220 forming structural assembly 200 may all be of substantially the same length (e.g., or of varying length). In at least some exemplary embodiments, vertical members 230 forming structural assembly 200 may all be of substantially the same length (e.g., or of varying length). In at least some exemplary embodiments, horizontal members 220 may be longer than vertical members 230. For example, horizontal members 220 may be about twice as longer as vertical members 230. Also for example, horizontal members 220 may be between about 1.5 times and 3 times as long as vertical members 230. In at least some exemplary embodiments, horizontal members 220 may be between about 3 feet and about 7 feet long (e.g., about 5 feet long), and vertical members 230 may be between about 1 foot and about 5 feet long (e.g., about 2.5 feet long). In at least some exemplary embodiments, horizontal members 220 and/or vertical members 230 may be hollow members (e.g., pipes) having diameters or widths of between about ½″ and about 3″, between about ¾″ and about 2″ (e.g., about 1″), or any other suitable size.

Horizontal members 220 and vertical members 230 may be attached together by the exemplary disclosed mechanical connectors to form structural assembly 200 having any desired size, shape, and/or configuration. For example as illustrated in FIG. 3, horizontal members 220 and vertical members 230 may be attached together to form structural assembly 200 as a frame. For example, moment, shear, and axial forces may be transferred between members 220 and 230 via the exemplary disclosed mechanical connectors. Members 220 and 230 may thereby for example form a substantially rigid structure that may effectively transfer significant gravity loads, wind loads, snow loads, and/or any other suitable loads between the exemplary disclosed structural members and to ground surface 150 without losing structural integrity. For example, structural assembly 200 may be formed as a prismatic and/or cubic frame that may be symmetrical about two axes (e.g., two vertical axes). For example, horizontal members 220 and vertical members 230 may be attached together to form prismatic and/or cubic structural assembly 200 having substantially similar four quarters as illustrated in FIG. 3. Structural assembly 200 may also be formed by members that may be similar to members 220 and 230 and that may be disposed at angles from a horizontal and/or vertical plane (e.g., may be disposed diagonally). Structural assembly 200 may also be formed by members that may be similar to members 220 and 230 and that may be of varying lengths so as to form an irregular and/or asymmetrical configuration. Structural assembly 200 may also be formed by members that may be similar to members 220 and 230 and that may form structural systems such as trusses in which members may be axial members (e.g., tension and compression members), suspension structures (e.g., including suspension members such as tension members), and/or any other suitable structural system.

The exemplary disclosed mechanical connectors may be any suitable connectors for transferring forces between the exemplary disclosed structural members (e.g., members 220 and 230). For example, the exemplary disclosed mechanical connectors may form moment connections that may transfer moment, shear, and axial forces between members (e.g., or pinned connections that may transfer axial forces, or any other suitable connection). The exemplary disclosed mechanical connectors may be formed from similar material as described above regarding horizontal member 220. In at least some exemplary embodiments, the exemplary disclosed mechanical connectors may be pipe fittings (e.g., PVC or ABS pipe fittings) and/or any other suitable connectors for connecting the exemplary disclosed types of members described above regarding members 220 and 230.

The exemplary disclosed mechanical connectors may be any suitable connectors for being removably fastened to the exemplary disclosed members (e.g., for removably attaching the exemplary disclosed members such as members 220 and 230). The exemplary disclosed mechanical connectors may include recesses and/or apertures for receiving end portions of the exemplary disclosed members. The exemplary disclosed mechanical connectors may include clamps, screws, bolts, pins, and/or any other suitable fasteners for fastening (e.g., removably fastening, or in some embodiments permanently attaching) a plurality of the exemplary disclosed members to the exemplary disclosed mechanical connectors. In at least some exemplary embodiments, the exemplary disclosed members and mechanical connectors may be connected via snap-fit connection, press-fit connection, adhesive, hook and loop fasteners, magnetic fasteners, mechanical fasteners, and/or any other suitable attachment technique (e.g., for removable attachment). The exemplary disclosed mechanical connectors may be configured to attach members at various relative orientations such as, for example, perpendicular to each other in any of three dimensions and/or at an angle to each other in any of three dimensions. The exemplary disclosed mechanical connectors may include one or more 3-way connectors 235, one or more 4-way connectors 240, one or more 5-way connectors 245, one or more 6-way connectors 250, and/or one or more connectors for connecting any other desired number of members.

3-way connector 235 may include three attachment points such as ports, recesses, and/or points for connecting to members using the exemplary disclosed attachment techniques described above. In at least some exemplary embodiments, 3-way connector 235 may be a 3-way PVC or ABS pipe fitting (e.g., or any other desired connector using the exemplary disclosed attachment techniques described above). 3-way connector 235 may removably attach three exemplary disclosed members of structural assembly 200. For example as illustrated in FIGS. 3, 3-way connector 235 may removably attach two horizontal members 220 and one vertical member 230 for example at top corner locations of structural assembly 200.

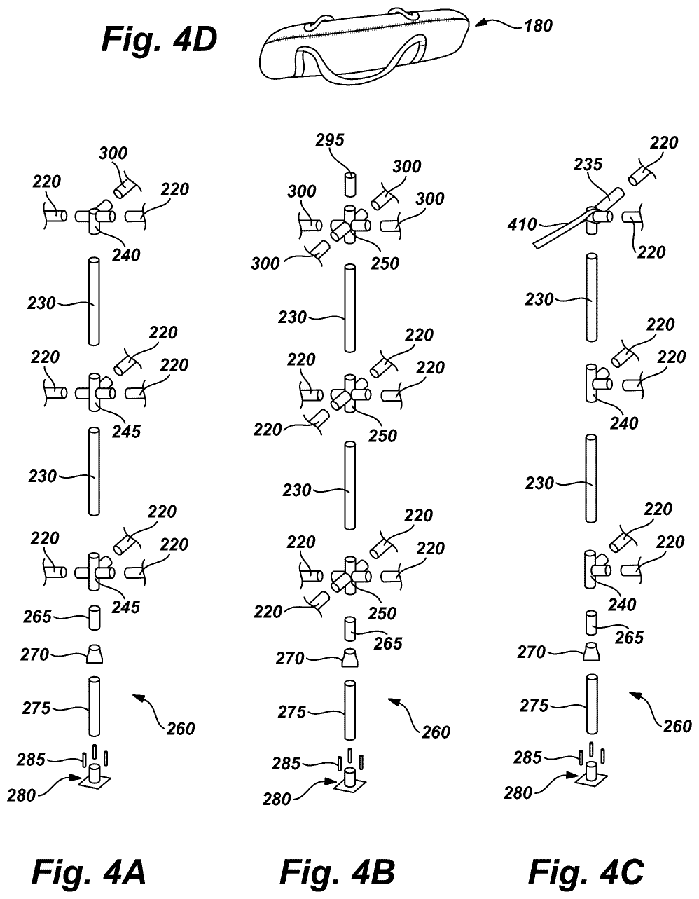

4-way connector 240 may include four attachment points such as ports, recesses, and/or points for connecting to members using the exemplary disclosed attachment techniques described above. In at least some exemplary embodiments, 4-way connector 240 may be a 4-way PVC or ABS pipe fitting (e.g., or any other desired connector using the exemplary disclosed attachment techniques described above). 4-way connector 240 may removably attach four exemplary disclosed members of structural assembly 200. For example as illustrated in FIGS. 3, 4-way connector 240 may removably attach one or more horizontal members 220, one or more vertical members 230, an exemplary disclosed member (e.g., described below) of upper assembly 205, and/or an exemplary disclosed member (e.g., described below) of lower assembly 215 together for example at top middle locations and/or side corner locations of structural assembly 200.

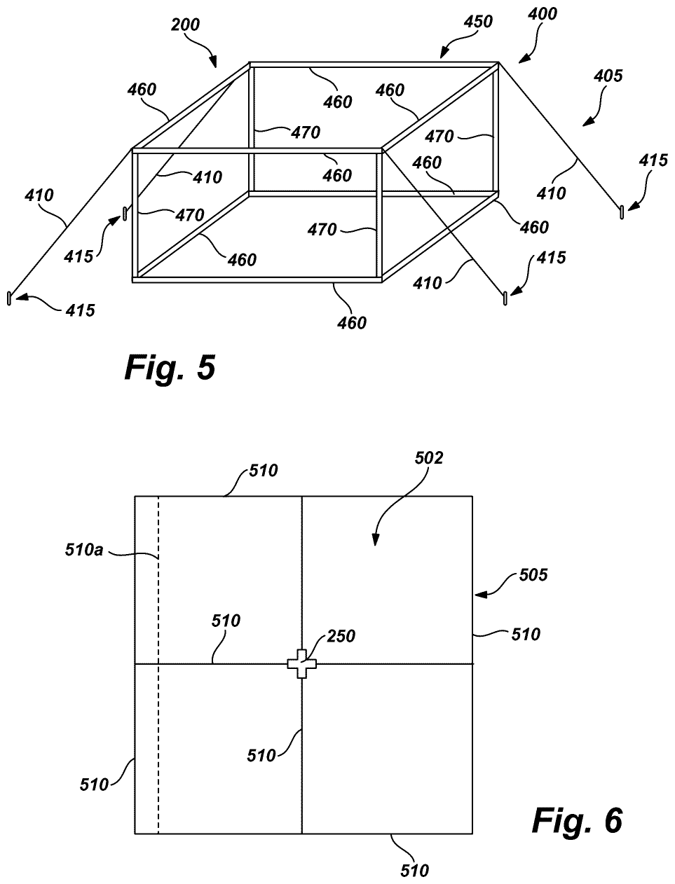

5-way connector 245 may include five attachment points such as ports, recesses, and/or points for connecting to members using the exemplary disclosed attachment techniques described above. In at least some exemplary embodiments, 5-way connector 245 may be a 5-way PVC or ABS pipe fitting (e.g., or any other desired connector using the exemplary disclosed attachment techniques described above). 5-way connector 245 may removably attach five exemplary disclosed members of structural assembly 200 together. For example as illustrated in FIGS. 3, 5-way connector 245 may removably attach three horizontal members 220, one or more vertical members 230, and/or an exemplary disclosed member of lower assembly 215 together for example at side middle locations of structural assembly 200.

6-way connector 250 may include six attachment points such as ports, recesses, and/or points for connecting to members using the exemplary disclosed attachment techniques described above. In at least some exemplary embodiments, 6-way connector 250 may be a 6-way PVC or ABS pipe fitting (e.g., or any other desired connector using the exemplary disclosed attachment techniques described above). 6-way connector 250 may removably attach six exemplary disclosed members of structural assembly 200 together. For example as illustrated in FIGS. 3, 6-way connector 250 may removably attach four horizontal members 220 or four exemplary disclosed members of upper assembly 205, one or more vertical members 230, and/or an exemplary disclosed member of lower assembly 215 together for example at center locations of structural assembly 200.

FIGS. 4A, 4B, and 4C provide detailed, exploded views of portions of structural assembly 200. FIG. 4A provides an exemplary illustration of one of four column lines (e.g., vertical lines) at middle side locations of structural assembly 200 illustrated in FIG. 3. FIG. 4B provides an exemplary illustration of the column line (e.g., vertical line) at the center location of structural assembly 200 illustrated in FIG. 3 (e.g., at a central portion of the exemplary disclosed interior area formed by structural assembly 200). FIG. 4C provides an exemplary illustration of one of four vertical lines (e.g., column lines) at corner locations of structural assembly 200 illustrated in FIG. 3. FIGS. 4A, 4B, and 4C illustrate portions of main assembly 210 described above, and also illustrate portions of upper assembly 205 and lower assembly 215 described further below. The column lines illustrated in FIGS. 4A and 4C may form a plurality of exterior column lines disposed at a periphery of the exemplary disclosed interior area, each of the exterior column lines anchored in the ground surface via a plurality of anchors as described below. For example, FIG. 4A illustrates middle side column lines of the plurality of exterior column lines, and FIG. 4C illustrates corner column lines of the plurality of exterior column lines.

As illustrated in FIGS. 3, 4A, 4B, and 4C, lower assembly 215 may include a plurality of lower subassemblies 260. For example, a lower subassembly 260 may be attached at lowermost 4-way connectors 240 at the corner column lines of structural assembly 200, lowermost 5-way connectors 245 at the middle side column lines of structural assembly 200, and lowermost 6-way connector 250 at the center column line of structural assembly 200 (e.g., for a total of nine lower subassemblies as illustrated in FIG. 3).

The exemplary disclosed components of lower subassemblies 260 described below may be formed from materials similar to the exemplary disclosed materials described above regarding horizontal member 220. Each lower subassembly 260 may include a first foot member 265, a reducer coupling 270, a second foot member 275, a foot flange 280, and a plurality of flange anchors 285.

First foot member 265 and second foot member 275 may be generally similar to horizontal member 220 and vertical member 230. First foot member 265 and second foot member 275 may be shorter than vertical member 230. For example, first foot member 265 may be between about ⅛ and about ⅓ as long as vertical member 230, or between about ⅙ and about ¼ as long as vertical member 230 (e.g., about ⅕ as long as vertical member 230). In at least some exemplary embodiments, first foot member 265 may be between about 3″ and about 2 feet in length, or between about 4″ and about 1 foot in length (e.g., about 6″ in length). Also for example, second foot member 275 may be between about ⅗ as long and about as long (e.g., the substantially same length) as vertical member 230, or about ⅘ as long as vertical member 230. In at least some exemplary embodiments, second foot member 275 may be between about 1 foot and about 5 feet in length, or between about 1.5 feet and about 3 feet in length (e.g., about 2 feet in length). Also for example, second foot member 275 may be longer than first foot member 265. For example, second foot member 275 may be between about two times and about six times longer than first foot member 265, or between about three times and about five times longer (e.g., about four times longer) than first foot member 265.

In at least some exemplary embodiments, first foot member 265 and second foot member 275 may be hollow members (e.g., pipes) having diameters or widths of between above ½″ and about 3″, between about ¾″ and about 2″, or any other suitable size. Second foot member 275 may have a larger diameter than first foot member 265. For example, second foot member 275 may have a diameter that is between about a same diameter and two times a diameter of first foot member 265 (e.g., second foot member 275 may have a diameter that may be about 1.5 times a diameter of first foot member 265). In at least some exemplary embodiments, first foot member 265 may have a diameter of about 1″ and second foot member 275 may have a diameter of about 1.5″.

Reducer coupling 270 may be any suitable connector for connecting first foot member 265 and second foot member 275 having different diameters or widths (e.g., or a substantially same diameter or width). Reducer coupling 270 may be attached to first foot member 265 and second foot member 275 (e.g., and first foot member 265 may be attached to connectors 240, 245, and 250) via any of the exemplary disclosed attachment techniques described above. In at least some exemplary embodiments, reducer coupling 270 may be a pipe reducer fitting having different sized recesses for receiving and connecting differently sized members 265 and 275 (e.g., attaching second foot member 275 having a relatively larger diameter or width to first foot member 265 having a relatively smaller diameter or width).

Foot flange 280 may be any suitable member for contacting ground surface 150 to support apparatus 105. For example, foot flange 280 may include a flange that may form a substantially flat bottom surface of foot flange 280 that may contact (e.g., abut against or bear against) ground surface 150. For example, foot flange 280 may be attached to second foot member 275 via any of the exemplary disclosed attachment techniques described above. In at least some exemplary embodiments, foot flange 280 may be a flanged pipe fitting having a recess for receiving second foot member 275. Foot flange 280 may include a plurality of apertures for receiving flange anchors 285. Flange anchors 285 may be any suitable anchor for securing foot flange 280 to ground surface 150. For example, flange anchors 285 may be screw anchors (e.g., or auger anchors or helical anchors) of any suitable length such as, for example, between about 4″ and about 12″, or between about 6″ and about 10″ (e.g., about 8″). Any suitable number of flange anchors 285 may be received in a corresponding number of apertures of foot flange 280 and used to anchor foot flange 280 to ground surface 150 such as, for example, between two and four (e.g., three) or more flange anchors 285.

As illustrated in FIGS. 3, 4A, 4B, and 7, upper assembly 205 may include a plurality of upper subassemblies 290 and a center subassembly including a center member 295. For example, a plurality of (e.g., four) upper subassemblies 290 and center member 295 may be attached at an uppermost 6-way connector 250 of structural assembly 200. The exemplary described components of upper assembly 205 described below may be formed from materials similar to the exemplary disclosed materials described above regarding horizontal member 220.

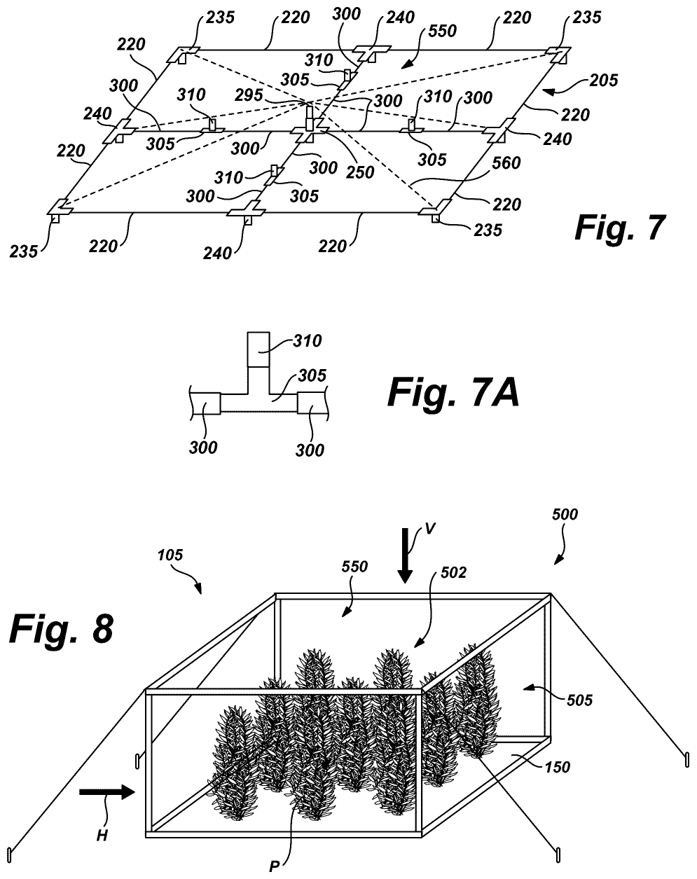

Each upper subassembly 290 may include a plurality of (e.g., two) upper members 300, a tee fitting 305, and a roof member 310. Upper members 300 may be similar to vertical members 230 (e.g., and in at least some exemplary embodiments may be identical to vertical members 230). Tee fitting 305 may be any suitable member for connecting upper members 300 and roof member 310 (e.g., as illustrated in FIG. 7A). In at least some exemplary embodiments, tee fitting 305 may be a pipe tee fitting including recesses for receiving upper members 300 and roof member 310. Upper members 300 and roof member 310 may be connected to tee fitting 305, upper members 300 may be connected to 4-way connectors 240 or 6-way connector 250, and center member 295 may be connected to 6-way connector 250 as illustrated in FIGS. 3 and 7 using any of the exemplary disclosed attachment techniques described above. For example, center member 295 may be attached to a center top portion of structural assembly 200 as illustrated in FIG. 3.

As illustrated in FIGS. 3, 4A, 4B, and 7, roof members 310 and center member 295 may be generally similar to horizontal member 220 (e.g., and first foot member 265). Roof members 310 and center member 295 may have any suitable diameter or width such as, for example, between about ½″ and about 2″ (e.g., about 1″). Center member 295 may be longer than roof member 310 so as to form a tapered top (e.g., roof) of apparatus 105 for example as described below regarding barrier assembly 500. In at least some exemplary embodiments, center member 295 may have a length of between about 1.5 times and about 3 times (e.g., about 2 times) a length of roof members 310. In at least some exemplary embodiments, center member 295 may have a length of between about 4″ and about 8″ (e.g., about 6″), and roof members 310 may have a length of between about 2″ and about 4″ (e.g., about 3″). Roof members 310 and/or center member 295 may include an end cap disposed at an upper portion of the members (e.g., a portion extending upwards such as substantially vertically upwards from tee fittings 305 and/or 6-way connector 250).

As illustrated in FIG. 5, bracing assembly 400 may include a side bracing assembly 405 and a frame bracing assembly 450. Side bracing assembly 405 and frame bracing assembly 450 may brace structural assembly 200, thereby increasing a structural integrity (e.g., structural stiffness, rigidity, strength, and/or resilience) of structural assembly 200.

Side bracing assembly 405 may include a plurality of bracing members such as a plurality of straps 410 and a plurality of side anchors 415. Straps 410 may be attached to top corners of structural assembly 200 (e.g., at 3-way connector 235 for example as illustrated in FIG. 4C and/or any other suitable exemplary disclosed structural member and/or mechanical connector). Returning to FIG. 5, each strap 410 may be attached between a top corner (e.g., or any other suitable location such as vertical member 230) of structural assembly 200 and side anchor 415. For example, four pairs of straps 410 and side anchors 415 may be disposed at corners (e.g., and/or sides) of structural assembly 200.

Side anchor 415 may be generally similar to flange anchor 285. In at least some exemplary embodiments, side anchor 415 may be longer than flange anchor 285. Side anchor 415 may be an auger anchor, a helical anchor, a screw anchor, and/or any other suitable configuration for being driven or screwed into ground surface 150. Side anchor 415 may be formed from materials similar to the exemplary disclosed materials described above regarding horizontal member 220 such as, for example, metal or plastic material. Side anchor 415 may have any suitable length such as, for example, between about 6″ and about 2 feet, between about 8″ and about 20″, or between about 10″ and about 16″ (e.g., about 12″).

Strap 410 may be any suitable bracing member for applying a tension force between an attachment point of structural assembly 200 and side anchor 415. Strap 410 may be attached to structural assembly 200 (e.g., at 3-way connector 235) and side anchor 415 via any suitable attachment technique such as, for example, mechanical fasteners (e.g., one or more carabiners, clamps, clips, bolts, and/or screws), and/or any other suitable technique for removable attachment (e.g., or permanent attachment) for example as described herein. Strap 410 may thereby be attached between a point of structural assembly 200 and side anchor 415. Strap 410 may be any suitable tension member. In at least some exemplary embodiments, strap 410 may be a ratchet strap. Strap 410 may also be a tie rod assembly (e.g., a tension rod including threaded tightening sleeves for introducing tension). Strap 410 may also be a cam buckle strap or any other suitable type of tension member for tightening (e.g., introducing force such as tensile force). In at least some exemplary embodiments, strap 410 may be a fabric or textile strap (e.g., polyester or nylon) including metal or plastic tighteners such as ratchet tighteners and/or cam buckles. Strap 410 may also be formed from metal and/or plastic material (e.g., and/or material similar to the exemplary disclosed material described above regarding horizontal member 220).

Straps 410 may be attached between points of structural assembly 200 and side anchors 415 as described above, and then tightened (e.g., using the exemplary disclosed mechanisms described above such as a ratchet device, a cam buckle device, threaded tightening sleeves, and/or any other suitable tightening mechanism). As straps 410 are tightened, tension forces developed in straps 410 may be introduced into structural assembly 200. For example, based on tightening structural assembly 200 from multiple sides by tightening multiple straps 410, structural assembly 200 may be tightened and/or tensioned, which may increase a structural integrity (e.g., structural stiffness, rigidity, strength, and/or resilience) of structural assembly 200.

Frame bracing assembly 450 may include a plurality of horizontal frame straps 460 and/or vertical frame straps 470 that may be similar to straps 410 for example as described above. As illustrated in FIG. 5, horizontal frame straps 460 may be attached to top corner points (e.g., at or near 3-way connectors 235) to introduce tension into structural assembly 200 (e.g., into upper horizontal members 220). Horizontal frame straps 460 may also be connected between lower corner points (e.g., at or near lowermost 4-way connectors 240) to introduce tension into structural assembly 200 (e.g., into lower horizontal members 220). Each vertical frame strap 470 may be attached to a top corner point (e.g., at or near 3-way connector 235) and a lower corner point (e.g., at or near lowermost 4-way connector 240) to introduce tension into structural assembly 200 (e.g., into vertical members 230). Vertical frame straps 470 may also similarly tension the exemplary disclosed middle side column lines illustrated in FIG. 4A and center column line illustrated in FIG. 4B. As horizontal frame straps 460 and/or vertical frame straps 470 are tightened, tension forces developed in horizontal frame straps 460 and/or vertical frame straps 470 may be introduced into structural assembly 200. For example, based on tightening structural assembly 200 at multiple locations by tightening multiple horizontal frame straps 460 and/or vertical frame straps 470, structural assembly 200 may be tightened and/or tensioned, which may increase a structural integrity (e.g., structural stiffness, rigidity, strength, and/or resilience) of structural assembly 200. In at least some exemplary embodiments, both horizontal frame straps 460 and vertical frame straps 470 may be used. In at least some exemplary embodiments, horizontal frame straps 460 (and no vertical frame straps 470) may be used. In at least some exemplary embodiments, vertical frame straps 470 (and no horizontal frame straps 460) may be used.

As illustrated in FIGS. 1, 2, 6, and 7, barrier assembly 500 may include a side barrier assembly 505 and a top barrier assembly 550. Side barrier assembly 505 and top barrier assembly 550 may provide barriers against access and/or weather to an interior area 502 of apparatus 105 (e.g., disposed inside of and bounded by portions of structural assembly 200 and barrier assembly 500).

As illustrated in FIGS. 1, 2, and 6, side barrier assembly 505 may include one or more side barriers 510 (e.g., a plurality such as two or more side barriers 510) and a plurality of barrier connectors 515 that may attach side barriers 510 to structural assembly 200.

As illustrated in the schematic plan view of FIG. 6 (e.g., and in FIGS. 1 and 2), one or more side barriers 510 may be attached to exterior sides of structural assembly 200 and may also be disposed at an interior of structural assembly 200 (e.g., including the center column line having 6-way connectors 250). At least one side barrier 510 may provide side walls to apparatus 105 (e.g., to structural assembly 200). Side barrier 510 may be an open mesh barrier (e.g., a mesh, netting, a screen, a meshed barrier, and/or any other suitable barrier allowing airflow). For example, side barrier 510 may be any suitable barrier for allowing air flow and blocking access by an object (e.g., an animal that may eat plants protected by apparatus 105). In at least some exemplary embodiments, side barrier 510 may be trellis netting (e.g., scrog netting). Side barrier 510 may be formed from flexible material such as fabric, textile, plastic, metal (e.g., metal wire), and/or any other suitable material for a barrier (e.g., and/or rigid material). In at least some exemplary embodiments, side barrier 510 may be fabric netting. Side barrier 510 may be provided in sections having any suitable dimensions for covering some or substantially all exterior and/or interior side portions of structural assembly 200. Also for example as illustrated in FIGS. 1 and 2, one or more access openings 504 (e.g., at lower assembly 215) may not be covered by side barrier 510, so as to allow desired selective access (e.g., by users tending to plants) to interior area 502. In at least some exemplary embodiments, side barrier 510 may be set back from an exterior of apparatus 105 (e.g., set back from the exemplary disclosed structural members disposed at the exterior of structural assembly 200) so that the exemplary disclosed top barrier described below extends beyond (e.g., forms an overhang over) one or more side barriers 510. For example as illustrated in FIG. 6, one or more side barriers 510a may be set back between about 6″ and about 18″ (e.g., about 12″) from one or more exterior sides of apparatus 105.

As illustrated in FIGS. 1 and 2, barrier connectors 515 may attach side barriers 510 to structural assembly 200. For example, barrier connectors 515 may connect side barriers 510 to structural assembly 200 by being received through an aperture of side barrier 510 (e.g., a netting hole) and being looped or wound around a portion of structural assembly 200 such as, for example, one or more horizontal members 220, vertical members 230, and/or exemplary disclosed mechanical connectors connecting the exemplary disclosed members. Barrier connectors 515 may be straps, mechanical fasteners (e.g., connectors including one or more clamps, clips, bolts, and/or screws), one or more hook and loop fasteners, magnetic components, fabric ties, rope, tape, adhesives, and/or any other suitable devices for removable attachment (e.g., or permanent attachment). In at least some exemplary embodiments, barrier connector 515 may be a bungee ball (e.g., a bungee cord ball that may be inserted through an aperture of side barrier 510 and wrapped around an exemplary disclosed member or connector of structural assembly 200). For example, barrier connector 515 may be a 6″ bungee ball (e.g., or bungee ball of any other suitable dimensions). In at least some exemplary embodiments, barrier connector 515 may be a soft loop tie-down strap.

As illustrated in FIGS. 1, 2, 7, and 7A, top barrier assembly 550 may include a top barrier 560. Top barrier 560 may be any suitable barrier for blocking precipitation and allowing light. For example, top barrier 560 may be a waterproof (e.g., waterproof and/or water resistant, for example for substantially blocking passage of a liquid) and translucent and/or transparent barrier. In at least some exemplary embodiments, top barrier 560 may be a tarp that may cover a top portion of structural assembly 200. For example, top barrier 560 may provide a roof to apparatus 105 (e.g., to structural assembly 200). Top barrier 560 may be supported by upper assembly 205 for example as illustrated in FIG. 7. Top barrier 560 may be a translucent and/or transparent plastic layer (e.g., a flexible or rigid plastic layer). Top barrier 560 may be formed from ultraviolet stable material that may be translucent and/or transparent. Top barrier 560 may be formed from UV plastic (e.g., ultraviolet stable plastic). Top barrier 560 may be a polycarbonate and/or polyethylene layer (e.g., film). In at least some exemplary embodiments, top barrier 560 may be formed from flexible plastic material that may be translucent and/or transparent. Top barrier 560 may be a greenhouse cover (e.g., a greenhouse tarp). Top barrier 560 may have a thickness of between about 2 mils and about 20 mils, between about 4 mils and about 18 mils, between about 5 mils and about 18 mils, or between about 6 mils and about 16 mils (e.g., about 6 mils, 10 mils, 16 mils, or any other suitable thickness). Top barrier 560 may be dimensioned to fit a top of structural assembly 200. For example, top barrier 560 may be a rectangle or square between about 5′×5′ (e.g., or less) and about 20′×20′ or more, between about 8′×8′ and about 15′×15′, or between about 8′×8′ and about 12′×12′ (e.g., a square with dimensions of about 10′×10′). Top barrier 560 may include apertures and/or fasteners to facilitate attachment of top barrier 560 to structural assembly 200. Top barrier 560 may be attached to structural assembly 200 via barrier connectors 515. Top barrier 560 may be attached to structural assembly 200 similarly to the exemplary disclosed attachment of side barrier 510 to structural assembly 200 for example as described above.

In at least some exemplary embodiments, top barrier 560 may be a rigid plastic or glass layer. For example, top barrier 560 may be formed from plastic board such as one or more HDPE boards, acrylic boards, polycarbonate boards, and/or any other suitable translucent and/or transparent material.

As illustrated in FIG. 7, top barrier 560 may be a flexible layer formed from one or more of the exemplary disclosed materials described above and configured to be in a tapered shape based on being supported by upper assembly 205. For example, center member 295, which may be longer than roof members 310 as described above, may configure top barrier 560 as having a relative greatest height at a center and then be tapered down based on support at roof members 310 to a relatively lowest height at exterior horizontal members 220 at a top of structural assembly 200. Center member 295 may thereby provide a roof peak to apparatus 105. For example, liquid such as rainwater may flow away from a center of top barrier 560 and toward (e.g., and drip off of) peripheral portions of top barrier 560. Debris such as leaves and other objects may be similarly moved away from a center of top barrier 560 and/or fall off of peripheral portions of top barrier 560. The exemplary disclosed taper of top barrier 560 may thereby help to keep top barrier assembly 550 relatively free of pooling liquid (e.g., rainwater), snow, debris such as leaves, and/or other material that may be disposed on top barrier 560.

As illustrated in FIG. 8, apparatus 105 may be configured to maintain structural stability against forces such as vertical forces V and/or horizontal forces H (e.g., and/or forces angled between vertical force V and horizontal force H). Forces (e.g., gravity forces) due to plants P protected by apparatus 105 may also be applied to apparatus 105. For example, plants P may be attached to upper assembly 205, main assembly 210, and/or other portions of structural assembly 200 (e.g., via connectors such as wire, string, rope, and/or any other suitable mechanical connector or other type of connector for example as described herein) to help support and promote growth of plants P. Structural assembly 200 (e.g., braced by bracing assembly 400 as described above) may support these loads. Additionally for example, vertical forces V such as precipitation and/or debris may be deflected and/or transferred off of apparatus 105 via tapered top barrier 560. Also for example, horizontal forces H such as wind loading may pass through side barrier assembly 505 (e.g., through mesh and/or netting of side barrier 510), reducing forces that may be exerted on apparatus 105 (e.g., on structural assembly 200). For example, structural assembly 200 (e.g., braced by bracing assembly 400 as described above) may withstand and maintain structural integrity during extreme weather events such as hurricanes, because high winds (e.g., horizontal forces H) may pass through side barriers 510 of side barrier assembly 505, thereby reducing forces exerted on structural assembly 200. Bracing assembly 400 may increase structural integrity (e.g., structural stiffness, rigidity, strength, and/or resilience) of structural assembly 200, thereby allowing apparatus 105 to withstand extreme weather conditions and/or other loadings (e.g., from horizontal forces H, vertical forces V, and/or from plants P) without being structurally compromised or significantly affected. Apparatus 105 may thereby continue to act as a plant shelter to one or more plants P.

FIG. 4D illustrates an exemplary disclosed container (e.g., a container 180) in which components of apparatus 105 may be stored and/or transported when disassembled (e.g., disassembled components for example as illustrated in FIGS. 4A, 4B, and 4C). For example when apparatus 105 is disassembled and not in use, the exemplary disclosed components may be disposed in container 180 and then stored and/or transported. Container 180 may be any suitable container such as, for example, a carrying case (e.g., a soft case bag, a hard case carrying box, or any other suitable transportation and storage container). For example, container 180 may be formed from flexible fabric, textiles, or plastic, and/or rigid plastic or metal. Container 180 may include fasteners such as zippers, clips, and/or buttons for allowing container 180 to be selectively opened and closed during use of container 180 to store and/or transport components of apparatus 105.

In at least some exemplary embodiments, horizontal members 220, vertical members 230, 3-way connectors 235, 4-way connectors 240, 5-way connectors 245, 6-way connectors 250, first foot members 265, reducer couplings 270, second foot members 275, foot flanges 280, center member 295, upper members 300, tee fittings 305, and/or roof members 310 may be formed from plastic pipe members and/or pipe fittings (e.g., PVC and/or ABS pipe members and/or pipe fittings).

The exemplary disclosed system, apparatus, and method may be used in any suitable application for growing plants. For example, the exemplary disclosed system, apparatus, and method may be used for providing a plant shelter such as an outdoor plant shelter. The exemplary disclosed system, apparatus, and method may be used to protect a large variety of plants from disease such as Bud Rot. For example, the exemplary disclosed system, apparatus, and method may be used to protect plants such as cannabis from disease and weather conditions both inside and outside of a natural growing season and/or a natural growing climate.

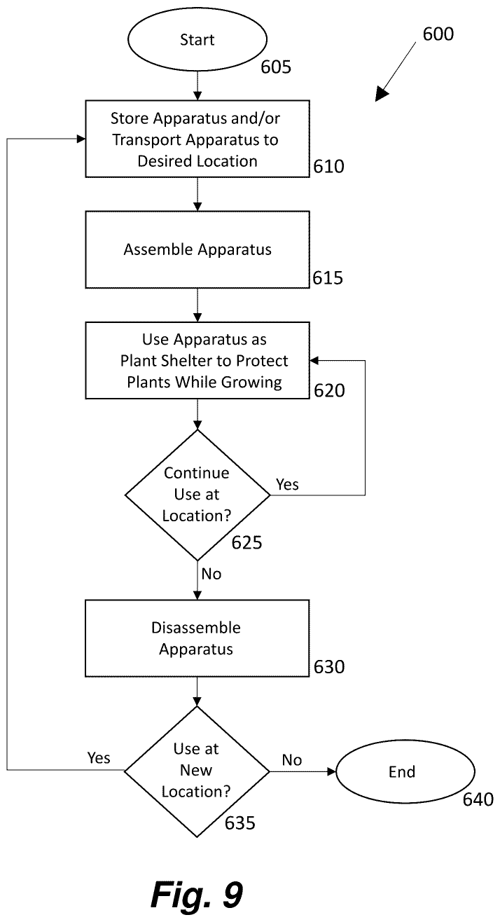

FIG. 9 illustrates an exemplary operation of shelter system 100. Process 600 begins at step 605. At step 610, apparatus 105 may be stored at a desired location and/or transported to a desired location using container 180. Apparatus 105 may be disassembled and the exemplary disclosed components of apparatus 105 may be disposed in container 180 in a disassembled configuration. For example, apparatus 105 may be substantially entirely disassembled into a disassembled kit including a plurality of members (e.g., disassembled and/or separate horizontal members 220 and vertical members 230), a plurality of mechanical connectors (e.g., disassembled and/or separate 3-way connectors 235, 4-way connectors 240, 5-way connectors 245, and 6-way connectors 250), a plurality of lower assembly components (e.g., disassembled and/or separate first foot members 265, reducer couplings 270, second foot members 275, foot flanges 280, and flange anchors 285), a plurality of upper assembly components (e.g., disassembled and/or separate center member 295, upper members 300, tee fittings 305, and roof members 310), a plurality of bracing assembly components (e.g., disassembled and/or separate straps 410, side anchors 415, horizontal frame straps 460, and vertical frame straps 470), and a plurality of barrier assembly components (e.g., disassembled and/or separate side barrier 510 or side barriers 510, barrier connectors 515, and top barrier 560). In at least some exemplary embodiments, apparatus 105 may be substantially entirely disassembled into a disassembled kit including a plurality of members (e.g., 32 horizontal members 220 and 18 vertical members 230), a plurality of mechanical connectors (e.g., four 3-way connectors 235, twelve 4-way connectors 240, eight 5-way connectors 245, and three 6-way connectors 250), a plurality of lower assembly components (e.g., 9 first foot members 265, 9 reducer couplings 270, 9 second foot members 275, 9 foot flanges 280, and 27 flange anchors 285), a plurality of upper assembly components (e.g., one center member 295, 8 upper members 300, 4 tee fittings 305, and 4 roof members 310), a plurality of bracing assembly components (e.g., 4 straps 410, 4 side anchors 415, four to eight horizontal frame straps 460, and four to eight vertical frame straps 470), and a plurality of barrier assembly components (e.g., one to six side barriers 510, 20 barrier connectors 515, and one top barrier 560). Container 180 containing the exemplary disclosed disassembled components may be stored at a desired location and/or transported to the desired location.

At step 615, the exemplary disclosed disassembled components of apparatus 105 (e.g., in the disassembled configuration for example stored and/or transported in a disassembled kit contained in container 180) may be assembled into apparatus 105 in an assembled configuration for example as illustrated in FIGS. 1 and 2. For example, the exemplary disclosed components of structural assembly 200 may be assembled as illustrated in FIG. 3 and described above. For example, flange anchors 285 may be driven into ground surface 150 to secure assembled structural assembly 200 to ground surface 150. Barrier assembly 500 may be attached to structural assembly 200 based on side barrier 510 and top barrier 560 being attached to structural assembly 200 using barrier connectors 515 for example as described above. Structural assembly 200 may be braced by bracing assembly 400 based on straps 410 being tensioned between structural assembly 200 and side anchors 415 (e.g., that may be driven into ground surface 150), and based on horizontal frame straps 460 and/or vertical frame straps 470 being attached to structural assembly 200 and tensioned for example as described above.

In at least some exemplary embodiments, the exemplary disclosed disassembled components of apparatus 105 may be removably attached together for example as described herein to form apparatus 105 in the assembled configuration. When the exemplary disclosed straps (e.g., and/or other exemplary disclosed bracing members) of bracing assembly 400 are tensioned for example as described above, the removably attached components of apparatus 105 may be tensioned together to increase and help maintain structural integrity (e.g., structural stiffness, rigidity, strength, and/or resilience) of apparatus 105 in the assembled configuration.

At step 620, apparatus 105 may be used as a plant shelter to protect plants P as plants P grow. Top barrier 560 may provide a protective (e.g., waterproof and translucent and/or transparent) overhead covering for plants P. One or more side barriers 510 may allow for airflow to pass (e.g., may allow for air to pass through mesh and/or apertures of side barrier 510). For example, this airflow (e.g., in combination with the shelter of top barrier 560) may significantly reduce or substantially stop Bud Rot from affecting plants P. The combination of top barrier 560 and one or more side barriers 510 may thereby provide favorable conditions and effects for promoting a healthy growth of plants P (e.g., including substantially preventing Bud Rot and other diseases, and protecting plants P against detrimental effects of ambient conditions such as precipitation and other weather conditions).

Structural assembly 200 (e.g., braced by bracing assembly 400 as described above) may withstand and maintain structural integrity, and continue to protect plants P, when apparatus 105 may be subjected to significant forces due to weather conditions (e.g., including extreme weather conditions) and/or other loadings (e.g., from horizontal forces H, vertical forces V, and/or from plants P). Based on maintaining structural integrity, apparatus 105 may thereby continue to act as a plant shelter to one or more plants P even during and/or after inclement or extreme weather events.

At step 625, it may be determined (e.g., by users of shelter system 100) whether or not to continue to use apparatus 105 at the present location. If apparatus 105 is to be continued to be used at the present location, process 600 may return to step 620. As many iterations as desired of steps 620 and 625 may be repeated. If use of apparatus 105 is not to be continued at the present location, process 600 may proceed to step 630.

At step 630, apparatus 105 may be disassembled. Bracing assembly 400 may be removed from structural assembly 200 based on straps 410 being loosened and side anchors 415 being removed from ground surface 150. Horizontal frame straps 460 and/or vertical frame straps 470 may also be loosened and detached from structural assembly 200. Barrier assembly 500 may be detached from structural assembly 200 based on barrier connectors 515 being removed and side barrier 510 and top barrier 560 being removed from structural assembly 200. Flange anchors 285 may be removed from ground surface 150. Structural assembly 200 may be disassembled. The disassembled exemplary disclosed components of apparatus 105 may be disposed in container 180.

At step 635, it may be determined (e.g., by users of shelter system 100) whether or not to use apparatus 105 at a new location. If apparatus 105 is to be used at a new location, process 600 may return to step 610. For example, apparatus 105 may be transported in the disassembled configuration (e.g., disassembled kit) using container 180. As many iterations as desired of steps 610 through 635 may be repeated. If use of apparatus 105 is not to be continued at a new location, process 600 ends at step 640.

The invention includes other illustrative embodiments (“Embodiments”) as follows.
Embodiment 1: A method, comprising: forming a structural assembly having an interior area based on removably attaching a plurality of structural members and a plurality of mechanical connectors; removably attaching a waterproof barrier to the structural assembly as a roof to the structural assembly, the waterproof barrier being at least one of translucent or transparent; removably attaching at least one open mesh barrier to the structural assembly as side walls to the structural assembly; removably attaching a plurality of bracing members to the structural assembly; and disposing plants in the interior area.
Embodiment 2: The method of Embodiment 1, further comprising detaching the plurality of bracing members, the open mesh barrier, the waterproof barrier, and the plurality of structural members and the plurality of mechanical connectors.
Embodiment 3: The method of Embodiment 2, further comprising: disposing the plurality of bracing members, the open mesh barrier, the waterproof barrier, the plurality of structural members, and the plurality of mechanical connectors into a container; and transporting the container.
Embodiment 4: The method of Embodiment 1, wherein the plurality of structural members are plastic pipes and the plurality of mechanical connectors are plastic pipe fittings.
Embodiment 5: The method of Embodiment 1, wherein the plurality of mechanical connectors include 3-way plastic fittings, 4-way plastic fittings, 5-way plastic fittings, and 6-way plastic fittings.
Embodiment 6: The method of Embodiment 1, wherein the at least one open mesh barrier includes fabric netting, an access opening to the interior area being formed between the fabric netting and a ground surface supporting the structural assembly.
Embodiment 7: The method of Embodiment 1, wherein disposing plants in the interior area includes disposing cannabis plants in the interior area.
Embodiment 8: The method of Embodiment 1, wherein attaching the waterproof barrier as the roof to the structural assembly includes tapering the waterproof barrier by supporting the waterproof barrier with a center member attached to a center top portion of the structural assembly that is taller than roof members disposed between the center member and sides of the structural assembly.
Embodiment 9: The method of Embodiment 1, wherein the structural members include a plurality of horizontal members disposed perpendicularly to a plurality of vertical members, each of the plurality of horizontal members being longer than each of the plurality of vertical members.
Embodiment 10: The method of Embodiment 9, wherein attaching the plurality of bracing members to the structural assembly includes at least one of attaching a tensioning strap along a line of the plurality of horizontal members or along a line of the plurality of vertical members.
Embodiment 11: The method of Embodiment 1, wherein attaching the plurality of bracing members to the structural assembly includes attaching a tensioning strap between the structural assembly and a side anchor driven into a ground surface supporting the structural assembly.
Embodiment 12: An apparatus for sheltering plants, comprising: a plurality of mechanical connectors including at least one of 3-way connectors or 4-way connectors and at least one of 5-way connectors or 6-way connectors; a plurality of structural members configured to be removably attached to the plurality of mechanical connectors; a waterproof barrier configured to be removably attached to the plurality of structural members using a plurality of barrier connectors, the waterproof barrier being at least one of translucent or transparent; at least one open mesh barrier configured to be removably attached to the plurality of structural members using the plurality of barrier connectors; and a plurality of tensioning straps configured to be removably attached to at least one of the plurality of structural members or the plurality of mechanical connectors.
Embodiment 13: The apparatus of Embodiment 12, wherein the plurality of mechanical connectors are PVC or ABS pipe fittings and the plurality of structural members are PVC or ABS pipes.
Embodiment 14: The apparatus of Embodiment 12, further comprising a container configured to contain the plurality of mechanical connectors, the plurality of structural members, the waterproof barrier, the plurality of barrier connectors, the at least one open mesh barrier, and the plurality of tensioning straps.
Embodiment 15: The apparatus of Embodiment 12, wherein the plurality of tensioning straps is a plurality of ratchet straps.
Embodiment 16: The apparatus of Embodiment 12, further comprising a plurality of plastic pipe tee fittings configured to taper the waterproof barrier based on attaching to a plurality of pipe upper members of different lengths of the apparatus.
Embodiment 17: A method, comprising: forming a structural assembly having an interior area based on removably attaching a plurality of plastic pipe members and a plurality of plastic pipe fittings; removably attaching a waterproof barrier to the structural assembly as a roof to the structural assembly, the waterproof barrier being at least one of translucent or transparent; removably attaching at least one open mesh barrier to the structural assembly as side walls to the structural assembly; removably attaching and tensioning a plurality of straps between the structural assembly and a plurality of side anchors disposed in a ground surface supporting the structural assembly; and disposing cannabis plants in the interior area.
Embodiment 18: The method of Embodiment 17, wherein the plurality of plastic pipe fittings includes a plurality of 6-way plastic pipe fittings disposed at a central portion of the interior area and attached to at least some of the plastic pipe members.
Embodiment 19: The method of Embodiment 17, wherein removably attaching the plurality of plastic pipe members and the plurality of plastic pipe fittings includes forming a plurality of exterior column lines at a periphery of the interior area, each of the exterior column lines anchored in the ground surface via a plurality of anchors.
Embodiment 20: The method of Embodiment 19, wherein the plurality of exterior column lines includes: a plurality of corner column lines each including one or more 3-way plastic pipe fittings and one or more 4-way plastic pipe fittings; and a plurality of middle side column lines each including one or more 4-way plastic pipe fittings and one or more 5-way plastic pipe fittings.

In at least some exemplary embodiments, the exemplary disclosed system, apparatus, and method may provide an efficient and effective system for protecting plants from weather conditions and/or disease. The exemplary disclosed system, apparatus, and method may provide a relatively low-cost outdoor growing shelter that may be structurally resilient enough to be used for an extended period of time, including months or up to years of use. The exemplary disclosed system, apparatus, and method may provide a relatively low-cost and durable plant shelter that may protect plants against disease.

It will be apparent to those skilled in the art that various modifications and variations can be made to the exemplary disclosed system, apparatus, and method. Other embodiments will be apparent to those skilled in the art from consideration of the specification and practice of the exemplary disclosed apparatus, system, and method. It is intended that the specification and examples be considered as exemplary, with a true scope being indicated by the following claims.

What is claimed is:

1. A method, comprising:
forming a structural assembly having an interior area based on removably attaching a plurality of structural members and a plurality of mechanical connectors;
removably attaching a waterproof barrier to the structural assembly as a roof to the structural assembly, the waterproof barrier being at least one of translucent or transparent;
removably attaching at least one open mesh barrier to the structural assembly as side walls to the structural assembly;
removably attaching a plurality of bracing members to the structural assembly; and
disposing plants in the interior area.

2. The method of claim 1, further comprising detaching the plurality of bracing members, the open mesh barrier, the waterproof barrier, and the plurality of structural members and the plurality of mechanical connectors.

3. The method of claim 2, further comprising:
disposing the plurality of bracing members, the open mesh barrier, the waterproof barrier, the plurality of structural members, and the plurality of mechanical connectors into a container; and
transporting the container.

4. The method of claim 1, wherein the plurality of structural members are plastic pipes and the plurality of mechanical connectors are plastic pipe fittings.

5. The method of claim 1, wherein the plurality of mechanical connectors include 3-way plastic fittings, 4-way plastic fittings, 5-way plastic fittings, and 6-way plastic fittings.

6. The method of claim 1, wherein the at least one open mesh barrier includes fabric netting, an access opening to the interior area being formed between the fabric netting and a ground surface supporting the structural assembly.

7. The method of claim 1, wherein disposing plants in the interior area includes disposing cannabis plants in the interior area.

8. The method of claim 1, wherein attaching the waterproof barrier as the roof to the structural assembly includes tapering the waterproof barrier by supporting the waterproof barrier with a center member attached to a center top portion of the structural assembly that is taller than roof members disposed between the center member and sides of the structural assembly.

9. The method of claim 1, wherein the structural members include a plurality of horizontal members disposed perpendicularly to a plurality of vertical members, each of the plurality of horizontal members being longer than each of the plurality of vertical members.

10. The method of claim 9, wherein attaching the plurality of bracing members to the structural assembly includes at least one of attaching a tensioning strap along a line of the plurality of horizontal members or along a line of the plurality of vertical members.

11. The method of claim 1, wherein attaching the plurality of bracing members to the structural assembly includes attaching a tensioning strap between the structural assembly and a side anchor driven into a ground surface supporting the structural assembly.

12. An apparatus for sheltering plants, comprising:
a plurality of mechanical connectors including at least one of 3-way connectors or 4-way connectors and at least one of 5-way connectors or 6-way connectors;
a plurality of structural members configured to be removably attached to the plurality of mechanical connectors;
a waterproof barrier configured to be removably attached to the plurality of structural members using a plurality of barrier connectors, the waterproof barrier being at least one of translucent or transparent;
at least one open mesh barrier configured to be removably attached to the plurality of structural members using the plurality of barrier connectors; and
a plurality of tensioning straps configured to be removably attached to at least one of the plurality of structural members or the plurality of mechanical connectors.

13. The apparatus of claim 12, wherein the plurality of mechanical connectors are PVC or ABS pipe fittings and the plurality of structural members are PVC or ABS pipes.

14. The apparatus of claim 12, further comprising a container configured to contain the plurality of mechanical connectors, the plurality of structural members, the waterproof barrier, the plurality of barrier connectors, the at least one open mesh barrier, and the plurality of tensioning straps.

15. The apparatus of claim 12, wherein the plurality of tensioning straps is a plurality of ratchet straps.

16. The apparatus of claim 12, further comprising a plurality of plastic pipe tee fittings configured to taper the waterproof barrier based on attaching to a plurality of pipe upper members of different lengths of the apparatus.

17. A method, comprising:
forming a structural assembly having an interior area based on removably attaching a plurality of plastic pipe members and a plurality of plastic pipe fittings;
removably attaching a waterproof barrier to the structural assembly as a roof to the structural assembly, the waterproof barrier being at least one of translucent or transparent;
removably attaching at least one open mesh barrier to the structural assembly as side walls to the structural assembly;
removably attaching and tensioning a plurality of straps between the structural assembly and a plurality of side anchors disposed in a ground surface supporting the structural assembly; and
disposing cannabis plants in the interior area.

18. The method of claim 17, wherein the plurality of plastic pipe fittings includes a plurality of 6-way plastic pipe fittings disposed at a central portion of the interior area and attached to at least some of the plastic pipe members.

19. The method of claim 17, wherein removably attaching the plurality of plastic pipe members and the plurality of plastic pipe fittings includes forming a plurality of exterior column lines at a periphery of the interior area, each of the exterior column lines anchored in the ground surface via a plurality of anchors.

20. The method of claim 19, wherein the plurality of exterior column lines includes:
a plurality of corner column lines each including one or more 3-way plastic pipe fittings and one or more 4-way plastic pipe fittings; and
a plurality of middle side column lines each including one or more 4-way plastic pipe fittings and one or more 5-way plastic pipe fittings.
